(19) United States
(12) Patent Application Publication
(10) Pub. No.: US 2006/0043112 A1
(43) Pub. Date: Mar. 2, 2006

(54) Transport mechanism for automated product dispenser

(76) Inventors: Mark J. Gilmore, Johnston, RI (US); Victor Collucci, West Palm Beach, FL (US)

Correspondence Address: BARLOW, JOSEPHS & HOLMES, LTD., 101 DYER STREET, 5TH FLOOR, PROVIDENCE, RI, 02903, US

(21) Appl. No.: 11/215,897

(22) Filed: Aug. 31, 2005

Related U.S. Application Data
(60) Provisional application No. 60/606,772, filed on Sep. 2, 2004.

(51) Int. Cl. B67D 5/60; B67D 5/64

(52) U.S. Cl. 222/130

(57) ABSTRACT

A remotely located product dispenser interfaced with a point of sale (POS) terminal is provided. To obtain product from the dispenser, a sale must first be entered in the POS terminal. After the sale is completed, the POS terminal communicates with the dispenser causing the dispenser to dispense the desired product in the purchased quantity. Further, the dispenser includes an improved mechanical transport system in the form of a collapsible gate that is connected to a belt. The transport system enables the dispenser to be configured for dispensing a much wider array of products.

### CROSS-REFERENCE TO RELATED APPLICATIONS

This application is related to and claims priority from earlier filed U.S. Provisional Patent Application No. 60/606,772, filed Sep. 2, 2004, the entire contents of which are incorporated herein by reference.

### BACKGROUND OF THE INVENTION

The present invention relates generally to product dispensers. More specifically, the present invention relates to transport mechanisms for use in dispensers that serve to dispense consumer products, particular those products having a high theft rate, such as cigarettes, razor blades, make-up, perfume and other expensive products.

In the retail industry, businesses are faced with the need to store inventories of a large variety of retail products in a convenient and organized fashion. Further, there is a need to control access to these products and track inventories of the products, while still allowing a customer to view the products and make a selection. To accommodate this need, in the prior art, there are many different types of product dispensers that are commonly used for commercial products. For many products, the solution is to simply place the products on open racks and shelving units that are distributed over the available retail floor area. Traditionally, the customers can view all of the available products, make their selections and take the desired products to a centralized cashier location to complete their purchases. While this solution works well for a large percentage of products that are offered for sale, there are other products that, due to their nature, are susceptible to theft, particularly by store employees. Often products that are susceptible to theft fall into one of several categories such as high cost products or highly controlled products. For example, high cost products that are contained in small packages such as razor blades or cosmetics are frequently stolen. Similarly, highly controlled and expensive products such as cigarettes are also frequently stolen.

In order to provide additional security for such high theft products, retailers have developed several specialty storage solutions in an attempt to provide better control over these products. For example, there are various known cigarette dispensers that are typically located behind the cash register and have a number of contained columns that received a stack of cigarette packs. In addition, larger columns are provided to accommodate cigarette cartons. An opening or slot is provided on the bottom of each of the dispenser columns that allows a cashier to remove one cigarette pack or carton at a time. Once an item is removed, gravity feeds the next item in the column to the opening for later removal. These prior art dispensers, however, are merely a physical structure for storing and dispensing the product to a person who has the authority to sell the product, such as a cashier. There is no way to track the inventory of the product in the dispenser or account for when a product is removed.

In this context, it can be appreciated that this type of solution does not eliminate the possibility of product theft. Using this arrangement, it is still possible for employees to remove product from unsecured inventory storage areas. For example, employees of the store selling the product may simply directly steal the product or give a customer more products than they actually purchased. In such a case, the cashier usually knows this person. Also, the possibility still exists for customers to reach behind the counter, at an unoccupied cashier station, and remove the cigarettes without paying for them. Therefore, the ability to accurately dispense and count product sold and track what is in inventory is critical.

One alternative is to control access to high theft products by placing all of them into a conventional vending machine. There are a large variety of vending machines available that provide a secure environment in which to store and dispense high theft products. They include a secure storage cabinet into which the products are placed and stored and only vend a selected product after payment for the product is received, thereby avoiding many of the above noted problems. Only trusted employees will have access to this storage area. However, such vending machines typically lack the necessary flexibility to dispense a variety of products. Further, vending machine tend to be bulky and would prove to be quite cumbersome should an array of vending machines be utilized to dispense each of the products for which security is needed. The use of such machines would also require that the customer make several separate purchases to obtain items for different machines. Finally, the transport system within a typical vending machine that is responsible for ejecting the selected product tends to be suited only for dispensing a very particularly sized and shaped package.

Therefore, there is a need for a product dispenser that can store and control the dispensing of a broad range of products. There is a further need to provide a vending machine that can dispense a wide range of products while occupying a compact space and providing a level of product control and security. Finally, there is a need for a dispenser to have an accurate transport mechanism for more precise inventory and sale tracking to better manage the product being dispensed therefrom.

### BRIEF SUMMARY OF THE INVENTION

In this regard, the present invention provides a product dispenser that includes a number of improvements over the dispensers of the prior art. Generally the present invention provides for a remotely located product dispenser thereby eliminating the need for an array of dispensers located around the retail store. The dispenser is positioned in a remotely located, secured location and is linked directly to a cash register or other point of sale (POS) terminal, thereby restricting physical access to the dispenser. A person of authority, such as a store manager, loads the desired products into the dispenser. Once the loading process is complete, the dispenser is locked, preventing unauthorized access to the products, thereby substantially reducing the possibility of employee theft.

In order to obtain any product from the dispenser, a sale must first be completed. In operation, a customer makes their selection at the cash register and pays for their desired products. After the sale is rung up, the cash register electronically communicates with the dispenser causing the dispenser to dispense the desired product in the purchased quantity. A product will only be dispensed from the dispenser after a customer has first paid for it at the register. Thus, each product dispensed will be paid for thereby reducing if not completely preventing product from being removed without payment (i.e. stolen).

Additional features provided by the dispenser of the present invention include the ability of the dispenser to electronically track the amount of product in a given storage column. Since the dispenser is electronically interconnected with the cash register, which in turn is interconnected to the company's network, inventory status of the products within the dispenser can be monitored to provide an indication when a particular dispenser needs to be re-filled or if more products need to be ordered. Further details of the electronic inventory tracking and cash register interconnection will be discussed in detail below. In addition, the dispenser of the present invention has an improved mechanical transport system that enables the dispenser of the present invention to be configured for dispensing a much wider array of products. The transport system employs a collapsible gate that is connected to a belt, which is in turn driven by a DC motor. In operation, the collapsible gate pushes the from the storage stack into a collection bin for retrieval by the cashier.

In view of the foregoing, an improved product dispenser is provided that prevents theft of the product therein while also tracking the inventory thereof. Additionally, an improved transport system is provided that requires a reduced amount of space in which to operate while also allowing the ability to handle a broader range of products. As a result, the dispenser of the present invention is superior to all prior art dispensers.

It is therefore an object of the present invention to provide a product dispensing system that can store and retain a wide variety of different products in a secured environment and dispense the selected products only after a purchase transaction has been completed. It is a further object of the present invention to provide a dispensing system wherein the dispenser can store and retain a wide variety of products in a reduced area while including a product transport system that can effectively and reliably dispense selected products in response to a signal generated by a POS terminal. It is yet a further object of the present invention to provide a dispensing system that includes a compact transport system that is capable of fully automated and reliable operation for the dispensing of a wide variety of selected products in response to a signal generated by a POS terminal.

These together with other objects of the invention, along with various features of novelty, which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a front perspective view of the automated product dispenser system of the present invention;

FIG. 2 is a rear perspective view of the transport system in the automated dispenser of the present invention;

FIG. 3 is a close-up rear perspective view of the actuator member;

FIG.4 is a close-up front perspective view of the actuator member; and

FIGS. 5A-5E are side view illustrations showing the transport system at various points of operation.

### DETAILED DESCRIPTION OF THE INVENTION

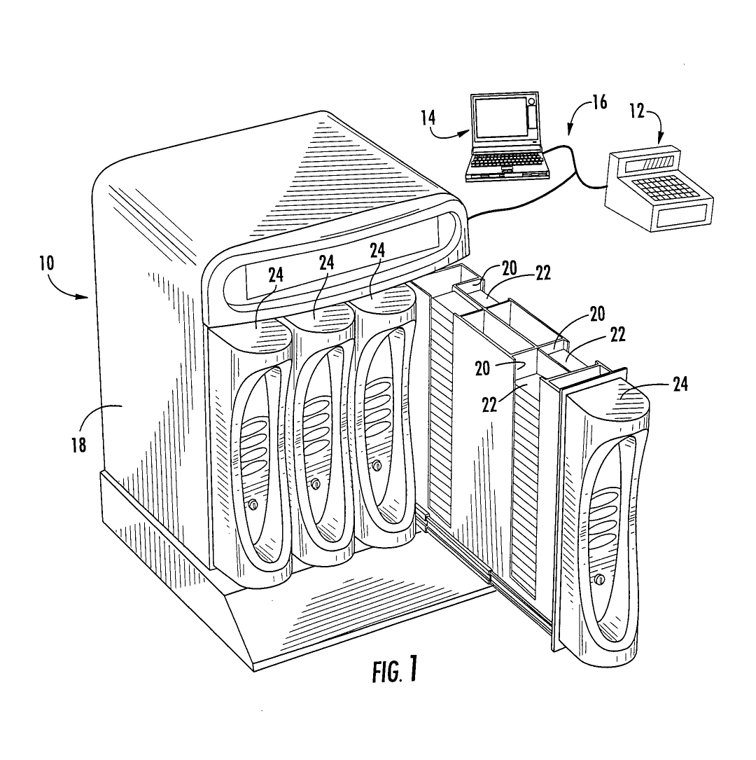

Now referring to the drawings, there is shown in FIG. 1 an illustration of the product dispenser system of the present invention. The system generally includes at least one product dispensing unit 10, at least one cash register or point of sale (POS) terminal 12 and a central data storage unit 14. Each of these devices is interconnected via an electronic communications network 16. Generally, in operation, in order to obtain any product from the product dispensing unit 10 a sale must first be completed. A customer makes their selection at the cash register 12 and pays for their desired products. After the sale is rung up, the cash register 12 electronically transmits the sale information via the electronic network 16 to the central data storage unit 14. The electronic communications network 16 allows the product dispensing unit 10 to monitor the electronic transmissions between the cash register 12 and the central data storage unit 14, thereby noting when a transaction has been completed that covers a product which is stored within the product dispensing unit 10. When a relevant transaction is completed and communicated, the product dispensing unit 10 notes the transmission signal and dispenses the desired product in the purchased quantity. A product will only be dispensed from the product dispensing unit 10 after a customer has first paid for it at the register 12.

The cash register or POS terminal 12 of the present invention may be any type register as is known in the prior art. Generally, the cash register 12 includes at least a cashier interface wherein the cashier can enter data that is associated the selections made by the customer and a network connection 16 wherein data entered by the cashier can be transferred to a central data storage unit 14. In this manner, as described above, as the cashier enters the selections made by the customer and the sale is completed, the transferred data signal will cause the product dispensing unit 10 to dispense the products required to complete the customer's order. One skilled in the art can appreciate that the cash register 12 may include a large variety of additional accessory devices and interfaces that increase the functionality of the cash register 12. For example, the cash register 12 may include a scanning device to read the bar codes located on each of the products selected by the customer. In such an arrangement, a customer may select tickets that are located in the retail store that correspond to the various items that are stored in the product dispensing unit 10. When such a ticket is scanned as part of a sale transaction, the product dispensing unit 10 will dispense the corresponding product. Similarly, the cash register 12 may include an additional user interface that is accessible by the customer. The additional interface may be an LCD panel with a keypad or a touch screen panel that provides a menu of items that are contained within the product dispensing unit 10. The customer can then select the desired products by making a selection on the customer interface. Once the selection is made, the transaction is completed as provided above.

The dispensing unit 10 may be triggered to dispense in many different ways, each of which are considered within the scope of the present invention. For example, a dedicated signal may be sent from the cash register to the dispenser to instruct what and how many products to dispense. Alternatively, the dispenser can be easily retrofitted to any cash register by connection to the monitor input for continuous capture what is being displayed on the monitor of the cash register. If a sale is recognized on the monitor, the appropriate instruction is sent to the dispenser. Further any signal being sent in any direction on the electronic communication network 16 could be monitored in order to cause the product dispensing unit 10 to dispense the requested product.

The central data storage unit 14 may be a computer terminal as is well known in the art. The central data storage unit 14 includes a system such as a software program for tracking inventories. The central data storage unit 14 may be located at the retail location itself wherein the central data storage unit 14 is responsible for tracking all of the sales information from each of the cash registers 12 within the retail location. Similarly, the central data storage unit 14 may be located at a remote location wherein the central data storage unit 14 tracks and stores the sales information from a plurality of cash registers 12 positioned within a plurality of remote retail locations. Further, there may be a hierarchy of central storage units 14 wherein a first level of central storage units 14 track the sales from the cash registers 12 at each discrete retail location and then each first level storage unit 14 transmits the data to a second level central storage unit at a remote location. It should be appreciated that may different arrangements are available and known in the art and any of these known configurations is intended to fall within the scope of the present invention.

The electronic communications network 16 disclosed in the present invention may be any network arrangement known in the art. The network 16 may be fully wired between each of the devices. Similarly, the network 16 may be a fully wireless arrangement that utilizes any one of the known wireless network protocols well known in the art. Further, the network 16 may be wired in part and wireless in part. The purpose of the electronic communications network 16 in the context of the present invention is simply to allow the product dispensing unit 10 to monitor transactional data that passes between the cash register 12 and the central data storage unit 14 and to allow the product dispensing unit 10 to transmit inventory related data to the central data storage unit 14. While it is preferred that the dispensing unit is connected to a network, where it communicates with a central data storage unit 14, it may operated in a standalone mode where inventory data is stored locally within the cash register 12 itself. Further, the transport mechanism of the present invention can be employed in an unattended vending machine environment that does not have any type of inventory tracking.

The product dispensing unit 10 is provided in the form of a large cabinet 18 that typically is located in a remote location, such as in a storage room. However, within the scope of the present invention the product dispensing unit 10 may be constructed for installation beneath a typical retail sales counter or the like. The product dispensing unit 10 includes at least one storage bin 20 for containing product 22 to be dispensed. The product 22 is stacked into the storage bin 20 in a substantially vertical fashion and contained therein while awaiting a customer purchase and dispensing of the product 22. In this arrangement, the product 22 is urged downward in the storage bin 20 by the force of gravity. Should the storage bin 20 be positioned in a different orientation, or should the product transport mechanism 26 be positioned at the top of the storage bin 20, the product 22 could be urged in the desired direction by a spring force. As is shown in FIG. 1, the present invention provides for an array of product storage bins 20 to be configured into a plurality of slide out racks 24, wherein four product storage bins 20 are provided in each slide out rack 24. While a particular configuration is shown herein, the details of the configuration are provided for the purpose of illustration only and it is anticipated that within the scope of the present invention, any array or configuration of product storage bins 20 is possible. To load products into the product storage bins 20, an authorized person, such as a manager, opens the slide out rack 24, stacks products 22 into each of the product storage bins 20, replaces the slide out rack 24 into the cabinet 18 and locks the slide out rack 24 thereby preventing access to the products 22 by any other person until the product 22 is dispensed. In this manner, various different slide out racks 24 that include product storage bins 20 having different sizes and shapes can be provided to facilitate storage and dispensing of a wide variety of different products 22. Each slide out rack 24 may be configured to accommodate a different variety of product 22 packages such as cigarettes, razor cartridge refills, cosmetics and the like. It is also anticipated that in the context of the present invention, a person would scan a bulk package of product 22 prior to loading the individual products 22 into the storage bins 20. This scanning step serves two functions. First, the product 22 being loaded into a particular storage bin 20 is identified so that the product dispensing unit 10 knows where the product 22 is located. Second, this provides additional inventory control in that if a bulk package containing ten packages of product 22 is scanned and only eight of those packages are loaded, a record is created thereby identifying the possibility of employee theft.

Once loaded, the product dispensing unit 10 tracks the inventory of the products 22 loaded therein. The product dispensing unit 10 provides this information by making it available on the electronic communications network 16 as well as maintaining a local inventory log thereby maintaining a back up record should the primary inventory tracking system or central data storage unit 14 fail.

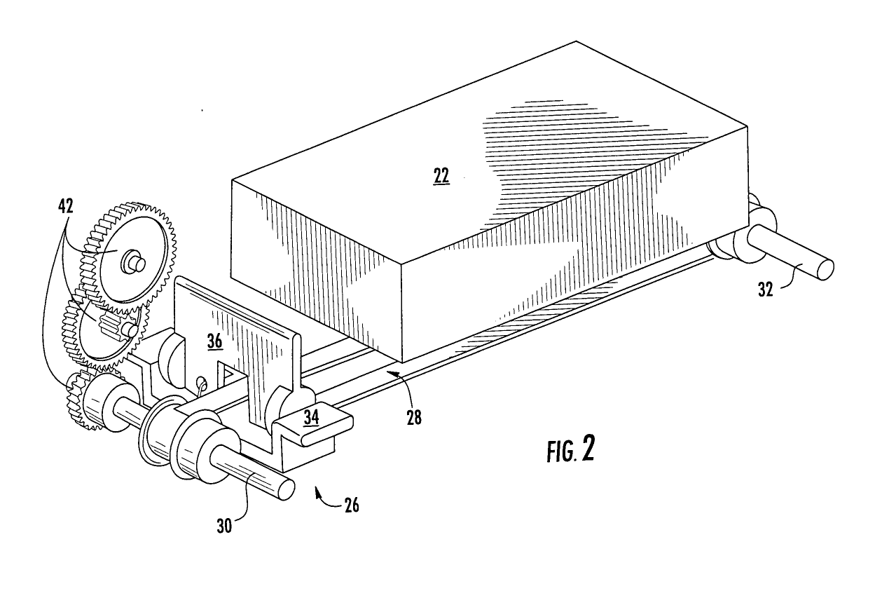

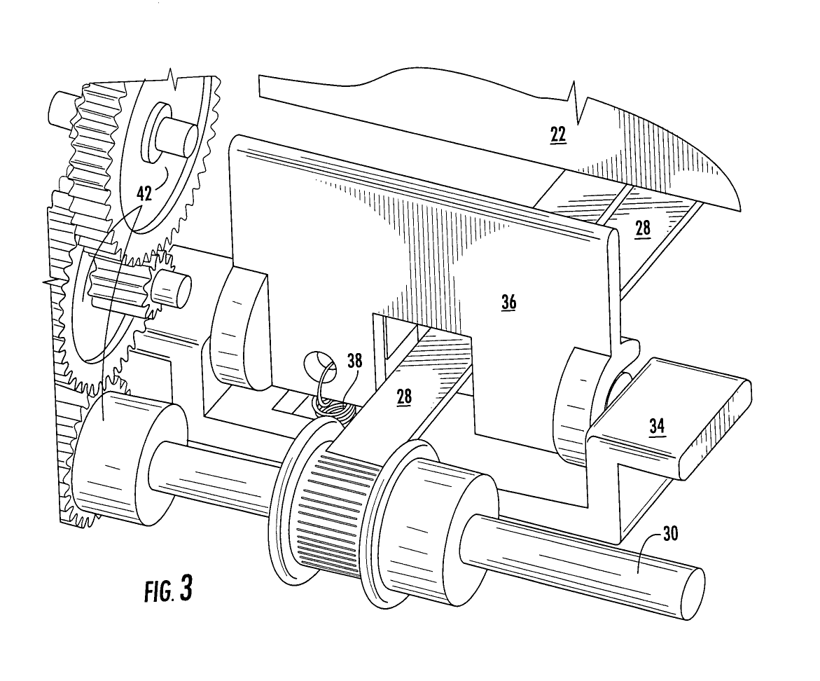

At the bottom of each of the product storage bins, a product transport assembly 26 is provided. Turning now to FIGS. 2, 3 and 4, an illustration of the product transport assembly 26 of the present invention is shown. The product transport assembly 26 is an electronically controlled device that serves to eject a single item from the product storage bin 20 in response to a dispense signal received by the product dispensing unit 10. In general, the product transport assembly 26 is a belt driven device that is configured to push the bottom product item 22 from the stack of product 22 within the storage bin 20. The product transport assembly 26 includes a belt 28 that extends between a rearward drive shaft 30 and a forward idle shaft 32. The belt 28 can be reciprocated in a forward and rearward direction between the drive shaft 30 and the idle shaft 32. A pushing assembly 34 is secured to the belt 28 and includes an arm 36 that is pivotally mounted onto the pushing assembly 34. The arm 36 has a spring 38 that extends to the pushing assembly 34 wherein the spring 38 creates a spring bias that urges the arm 36 to an upward position that is substantially perpendicular to the direction of travel of the belt 28 and the pushing assembly 34. An electronically controlled drive motor 40 is in communication with the drive shaft 30 in a manner that causes the drive shaft 30 to rotate as the drive motor 40 is energized. The drive motor 40 may be directly connected to the drive shaft 30, may use an additional belt to cause the drive shaft 30 to rotate or may employ a series of gears 42 to cause the drive shaft 30 to rotate. Such mechanical rotational linkages are all well known in the art and do not require additional description herein. The drive motor 40 is preferably a DC voltage stepper motor that can be electronically controlled in a fashion that allows the drive motor 40 to be rotated through a controlled and predictable duration with each actuation, although any suitable device for imparting rotational energy could be utilized.

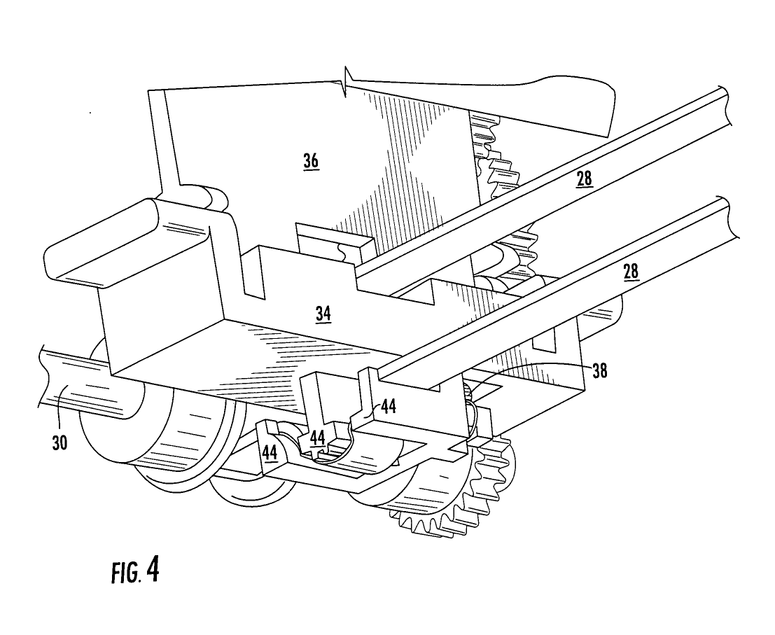

Turning now in particular to FIG. 4, the manner in which the pusher assembly 34 is attached to the drive belt 28 is shown. Preferably in the present invention the pusher assembly 34 is connected to the lower portion of the drive belt 28 in a manner that urges the pusher assembly 34 to move as the belt 28 is moved in a first or second direction. The means for attachment may be any known means for engaging a drive belt 28 such as a clamping or crimping assembly. In this case, the drive belt 28 is shown as being woven between clamping arms 44. While the pusher assembly 34 is shown as being connected to the lower portion of the drive belt 28, one skilled in the art can appreciate that the pusher assembly 34 could instead be connected to the upper portion of the drive belt 28 and function with equal efficiency within the scope of the present invention.

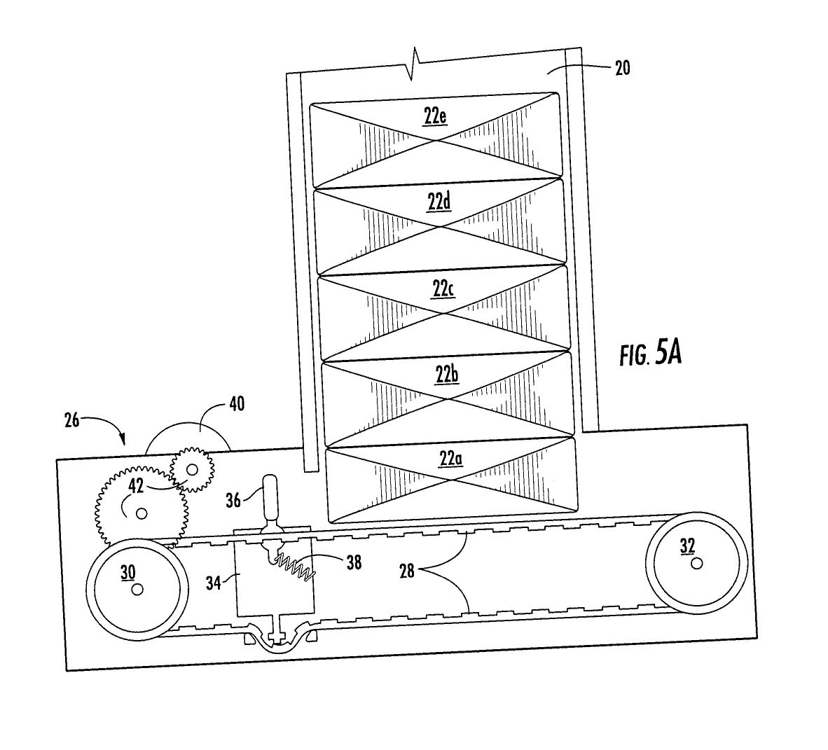

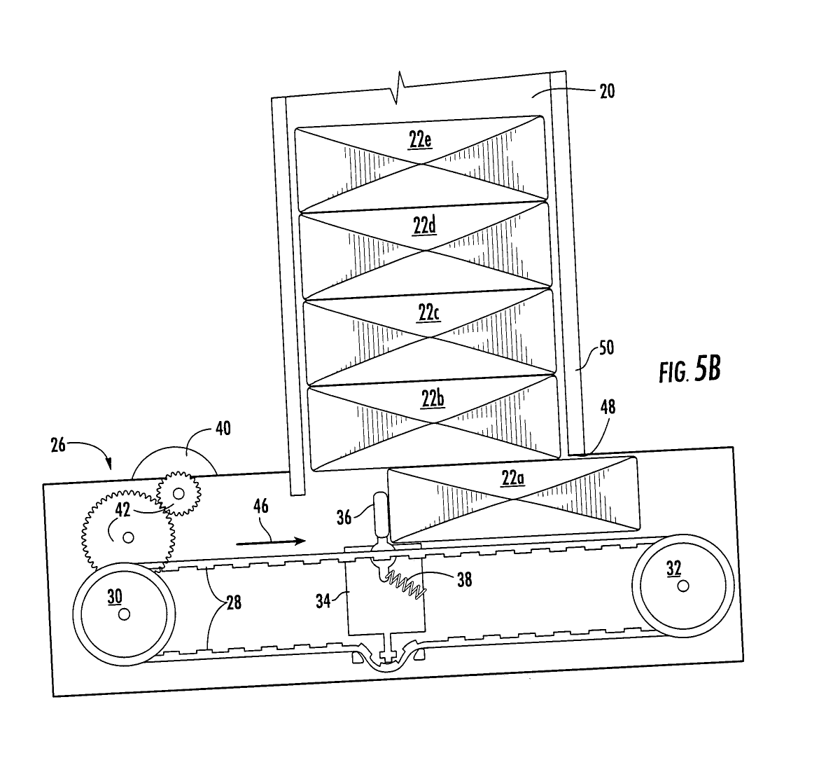

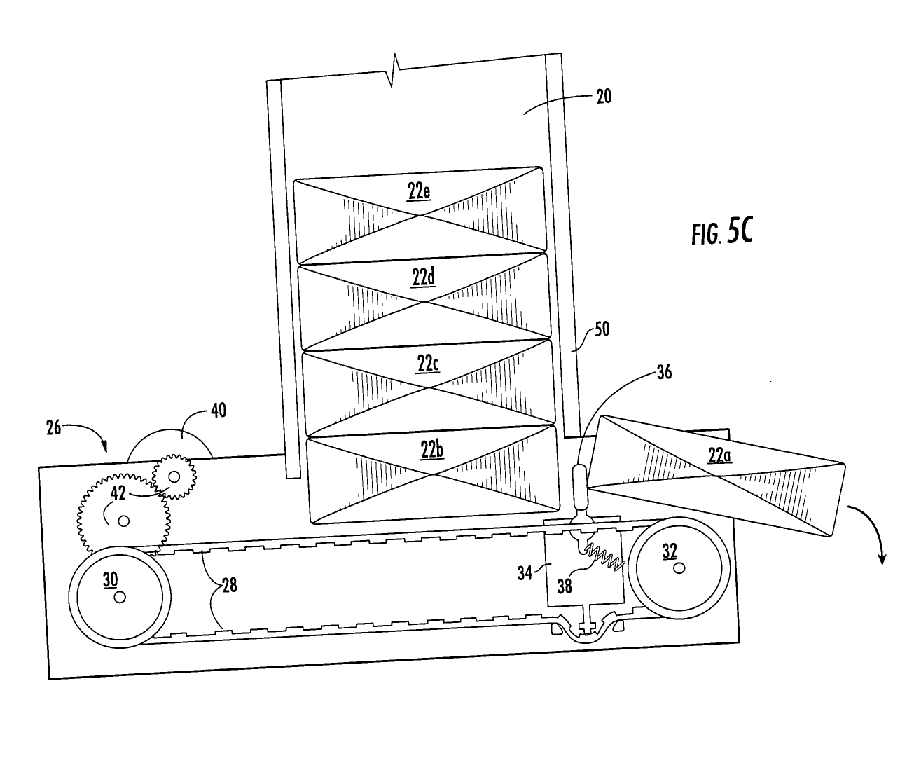

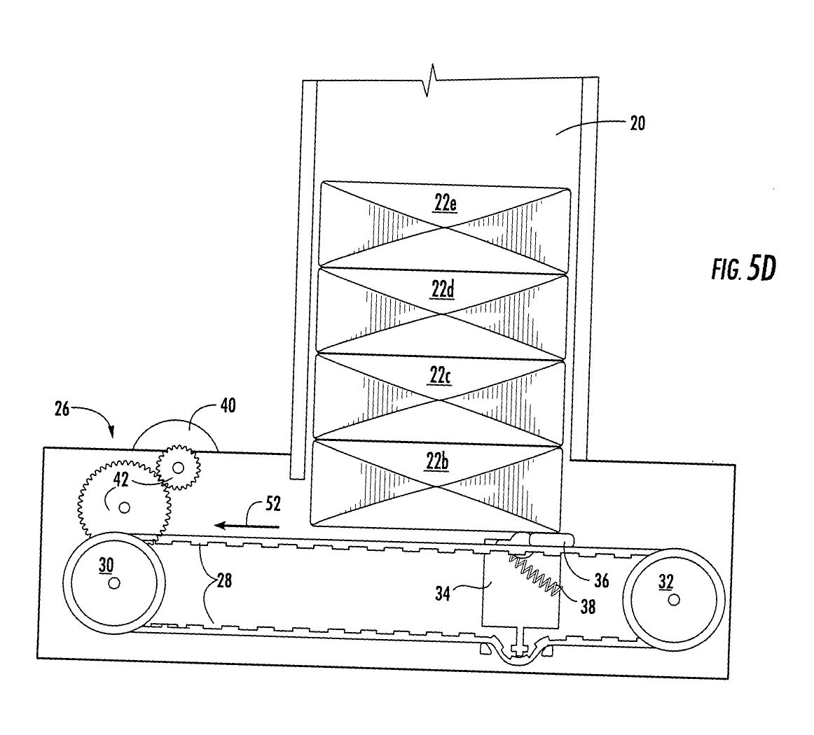

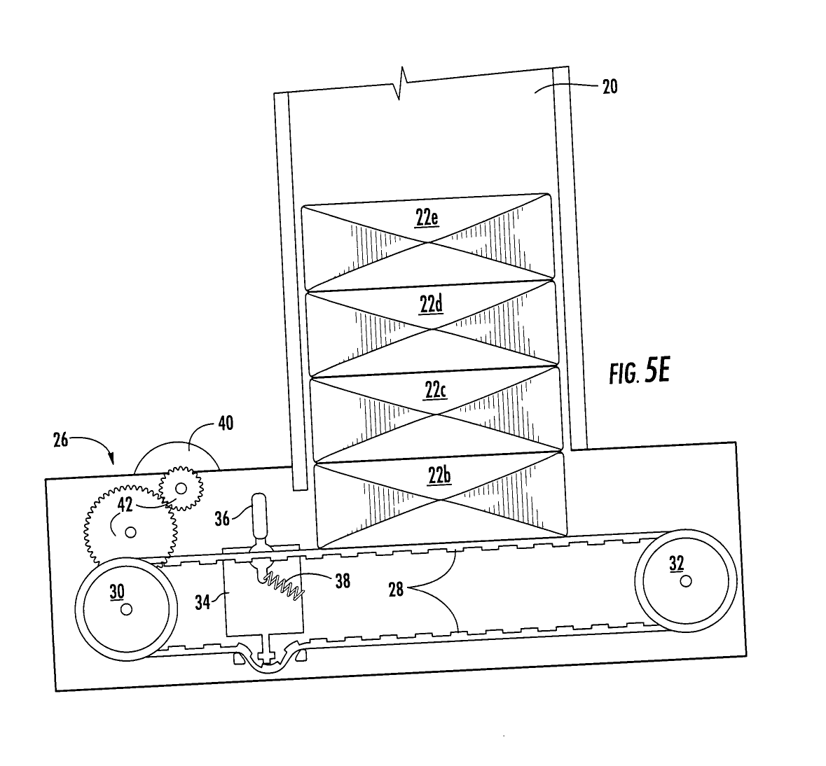

The operation of the transport assembly 26 of the present invention is detailed in FIGS. 5A-5E. FIGS. 5A-5E depict a sequential illustration of the transport mechanism 26 as it advances thorough a single dispensing operation. FIG. 5A depicts the transport mechanism 26 in its initial at rest, ready state. The pusher assembly 34 is shown in a first position behind the stack of product 22a-22e to be dispensed. The product 22a-22e to be dispensed can be seen stacked in the product storage bin 20, which is located above the transport assembly 26. The transport assembly 26 remains in this state until a dispense command is received by the product dispensing unit 10.

Turning to FIG. 5B, when the product dispensing unit 10 receives a dispense command, the product dispensing unit 10 sends a signal to the appropriate product transport assembly 26 to energize the drive motor 40. The drive motor 40 in turn causes the transport assembly 26 to begin to advance the drive belt 28 in a first direction 46. The pusher assembly 34 that is connected to the drive belt 28 is also advanced in the first direction 46 wherein the arm 36 engages the package of the bottom item of product 22a that is stacked within the product storage bin 20. This motion in turn urges the bottom product package 22a out from beneath the product stack 22b-22e and through an opening 48 in the wall 50 of the product storage bin 20. It can be seen that since this opening 48 is sized in a manner that only allows one product 22a to pass at a time, the remaining products 22b-22e in the stack are retained within the product storage bin 20. Of course, the wall 50 and the height of the arm 36 can be modified to push more than one product 22a, if desired.

FIG. 5C illustrates the pusher assembly 34 in a completely advanced position.

In this position the pusher assembly 34 has fully ejected the product package 22a from the product storage bin 20. At this point, the ejected product package 22a falls into a hopper for collection by the person making the purchase or the cashier. The remaining products 22b-22e in the product storage bin 20 drop downwardly onto the transport assembly 26 thereby positioning a new product package 22b in the appropriate position to be dispensed in a future dispensing operation. At this point, access to the products 22b-e is not possible.

FIG. 5D depicts the manner in which the pusher assembly 34 is reset for the next dispensing operation. The drive motor 40 is reversed causing the drive belt 28 to retract in a rearward second direction 52. As can be appreciated if the arm 36 on the pusher assembly 34 were rigidly affixed to the pusher assembly 34 the mechanism would not be able to be retracted. However, since the arm 36 is pivotally affixed to the pusher assembly 34, the arm 35 pivots downwardly allowing the entire pusher assembly 34 to slide beneath the product packages 22b-22e in the storage bin 20. Finally, FIG. 5E shows the pusher assembly 34 in the fully retracted position ready for the next dispense command. Once the arm 36 has cleared the underside of the product package 22b, the spring 38 urges the arm 36 back into an upright position perpendicular to the drive belt 28.

It should be appreciated while the transport assembly 26 of the present invention is shown in the context of a particular product dispensing system, the applicability of such an assembly is much broader. The transport assembly 26 of the present invention is clearly suited for any type of vending assembly wherein an electronically controlled transport mechanism 26 is required that is both compact and reliable. It can therefore be seen that the present invention provides a unique product inventory storage and control device that can be used in a retail operation to significantly reduce theft of commonly stolen items. The system of the present invention provides secured inventory control while including a compact and electronically controlled product transport mechanism that facilitates the storage and dispensing of a variety of differently sized and shaped product items. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A product dispensing device comprising:
a storage bin having a first end and a second end, said storage bin configured to receive and retain a plurality of product items to be dispensed; and
a product transport mechanism adjacent said second end of said storage bin, said product transport mechanism including:
a reciprocating drive assembly,
a carrier member attached to said reciprocating drive assembly, said drive assembly configured to move said carrier member linearly between a first position and a second position, and
an arm pivotally connected to said carrier member, said arm being spring biased to an engaged position, said arm being pivotally displaceable between said engaged position and a disengaged position substantially in the plane of said reciprocating drive.

2. The product dispensing device of claim 1, wherein activation of said drive assembly causes said drive assembly to move said carrier member from said first position to said second, said arm engaging and displacing a first product item at said second end of said storage bin thereby dispensing said first product, allowing a second product to advance to said second end of said storage bin;
said drive assembly then activating to move said carrier member from said second position to said first position, said arm contacting said second product and pivoting to said disengaged position as said carrier member passes beneath said second product;
said spring causing said arm to return to said engaged position once said carrier member returns to said first position.

3. The product dispensing device of claim 1, wherein said reciprocating drive assembly further comprises:
a drive shaft;
an idle shaft positioned in parallel spaced relation to said drive shaft;
a continuous loop drive belt extending between said drive shaft and said idle shaft; and
means for causing said drive shaft to rotate thereby causing said drive belt to a advance.

4. The product dispensing device of claim 3, wherein said means for causing said drive shaft to rotate is a motor.

5. The product dispensing device of claim 3, wherein said means for causing said drive shaft to rotate is a direct current motor.

6. The product dispensing device of claim 5, wherein said direct current motor is a stepper motor.

7. The product dispensing device of claim 1, wherein said storage bin is configured to maintain said products in a stack.

8. The product dispensing device of claim 7, wherein said stacked products are urged to said first end of said storage bin by gravity.

9. The product dispensing device of claim 7, wherein said stacked products are urged to said first end of said storage bin by a spring force.

10. The product dispensing device of claim 1, wherein said product storage bin is lockable.

11. The product dispensing device of claim 1, further comprising:
an array of product storage bins, each having a first end and a second end; and
an array of product transport mechanisms, each adjacent a second end of said array of product storage bins.

12. The product dispensing device of claim 11, wherein each of said product storage bins contains a different product from one another.

13. The product dispensing device of claim 11, wherein each of said product storage bins is lockable.

14. The product dispensing device of claim 1, further comprising:
an electronic interface device, said electronic interface device configured to interact with a customer who desires to purchase a product for the purpose of completing a transaction, said electronic device actuating said product transport mechanism to dispense said product once said transaction is completed.

15. A product dispensing system, comprising:
a product dispensing device including a plurality of storage bins each having a first end and a second end, each of said storage bins configured to receive and retain a plurality of product items to be dispensed;
a plurality of product transport mechanisms, each adjacent each of said second ends of said storage bins, said product transport mechanism including:
a reciprocating drive assembly;
a carrier member attached to said reciprocating drive assembly, said drive assembly configured to move said carrier member linearly between a first position and a second position; and
an arm pivotally connected to said carrier member, said arm being spring biased to an engaged position substantially perpendicular to said reciprocating drive, said arm being pivotally displaceable between said engaged position and a disengaged position substantially in the plane of said reciprocating drive; and
an electronic interface device, said electronic interface device configured to interact with a customer who desires to purchase a product for the purpose of completing a transaction, said electronic device actuating said product transport mechanism to dispense said product once said transaction is completed.

16. The product dispensing system of claim 15, wherein activation of said drive assembly causes said drive assembly to move said carrier member from said first position to said second, said arm engaging and displacing a first product item at said second end of said storage bin thereby dispensing said first product, allowing a second product to advance to said second end of said storage bin,
said drive assembly then activating to move said carrier member from said second position to said first position, said arm contacting said second product and pivoting to said disengaged position as said carrier member passes beneath said second product,
said spring causing said arm to return to said engaged position once said carrier member returns to said first position.

17. The product dispensing system of claim 15, wherein said reciprocating drive assembly further comprises:
a drive shaft;
an idle shaft positioned in parallel spaced relation to said drive shaft;
a continuous loop drive belt extending between said drive shaft and said idle shaft; and
means for causing said drive shaft to rotate thereby causing said drive belt to a advance.

18. The product dispensing system of claim 15, wherein said storage bin is configured to maintain said products in a stack.

19. The product dispensing system of claim 15, wherein each of said product storage bins contains a different product from one another.

20. The product dispensing system of claim 15, wherein each of said product storage bins is lockable.
